(19) United States
(12) Patent Application Publication
(10) Pub. No.: US 2012/0233991 A1
(43) Pub. Date: Sep. 20, 2012

(54) MULTI-FUNCTION MACHINES, HYDRAULIC SYSTEMS THEREFOR, AND METHODS FOR THEIR OPERATION

(75) Inventors: Monika Marianne Ivantysynova, Lafayette, IN (US); Joshua David Zimmerman, Lafayette, IN (US)

(73) Assignee: PURDUE RESEARCH FOUNDTION, West Lafayette, IN (US)

(21) Appl. No.: 13/422,802

(22) Filed: Mar. 16, 2012

Related U.S. Application Data
(60) Provisional application No. 61/453,368, filed on Mar. 16, 2011.

(51) Int. Cl. F15B 1/02

(52) U.S. Cl. 60/327; 60/413

(57) ABSTRACT

Systems and methods for controlling and actuating actuators that perform multiple functions in a machine. Such systems and methods encompass a hydraulic system adapted to control and actuate the actuators of the machine. The hydraulic system includes variable displacement pump/motors connected to the engine in parallel. A first of the pump/motors controls a first of the actuators, and a second of the pump/motors is adapted to draw power from and deliver power to the engine and the first actuator, as well as control at least a second of the actuators. An energy storage device is connected in series with the second pump/motor and the second actuator, and accumulates a fluid pumped thereto by the second pump/motor, as well as delivers the fluid to the second pump/motor, depending on whether the second pump/motor delivers is delivering or drawing power from the engine or first actuators.

### CROSS REFERENCE TO RELATED APPLICATIONS

This application claims the benefit of U.S. Provisional Application No. 61/453,368, filed Mar. 16, 2011, the contents of which are incorporated herein by reference.

### BACKGROUND OF THE INVENTION

The present invention generally relates to systems for operating hydraulic circuits. More particularly, this invention relates to hydraulic systems containing multiple displacement-controlled (DC) actuators, for example, of a multi-function machine, and an energy storage system therefor.

Compact excavators, wheel loaders and skid-steer loaders are examples of multi-function machines whose operations involve controlling movements of various implements of the machines. FIG. 1 illustrates a compact excavator 100 as having a cab 101 mounted on an undercarriage 102 via a swing bearing (not shown) or other suitable device. The undercarriage 102 includes tracks 103 and associated drive components, such as drive sprockets, rollers, idlers, etc. The excavator 100 is further equipped with a blade 104 and an articulating mechanical arm 105 comprising a boom 106, a stick 107, and an attachment 108 represented as a bucket, though it should be understood that a variety of different attachments could be mounted to the arm 105. The functions of the excavator 100 include the motions of the boom 106, stick 107 and bucket 108, the offset of the arm 105 during excavation operations with the bucket 108, the motion of the blade 104 during grading operations, the swing motion for rotating the cab 101, and the left and right travel motions of the tracks 103 during movement of the excavator 100. In the case of a compact excavator 100 of the type represented in FIG. 1, the blade 104, boom 106, stick 107, bucket 108 and offset functions are typically powered with linear actuators 109-114 (represented as hydraulic cylinders in FIG. 1), while the travel and swing functions are typically powered with rotary hydraulic motors (not shown in FIG. 1).

On conventional excavators, the control of these functions is accomplished by means of directional control valves. However, throttling flow through control valves is known to waste energy. In some current machines, the rotary functions (rotary hydraulic drive motors for the tracks 103 and rotary hydraulic swing motor for the cabin 101) are realized using displacement control (DC) systems, which notably exhibit lower power losses and allow energy recovery. In contrast, the position and velocity of the linear actuators 109-114 for the blade 104, boom 106, stick 107, bucket 108, and offset functions typically remain controlled with directional control valves. It is also possible to control linear hydraulic actuators directly with hydraulic pumps. Several pump-controlled configurations are known, using both constant and variable displacement pumps. Displacement control of linear actuators with single rod cylinders has been described in U.S. Pat. No. 5,329,767 and German Patents DE000010303360A1, EP000001588057A1 and WO002004067969. Other aspects of using displacement control systems can be better appreciated from further reference to Zimmerman et al., “The Effect of System Pressure Level on the Energy Consumption of Displacement Controlled Actuator Systems,” Proc. of the 5th FPNI PhD Symposium, Cracow, Poland, 77-92 (2008), and Williamson et al., “Efficiency Study of an Excavator Hydraulic System Based on Displacement-Controlled Actuators,” Bath ASME Symposium on Fluid Power and Motion Control (FPMC2008), 291-307 (2008), whose contents are incorporated herein by reference. An example of the capability of achieving reductions in energy requirements using displacement control systems is taught in U.S. Published Patent Application No. 2010/0162593, whose contents are incorporated herein by reference.

### BRIEF DESCRIPTION OF THE INVENTION

The present invention provides a system and method for controlling and actuating multiple actuators that perform multiple functions in a machine using variable displacement pumps.

According to a first aspect of the invention, a hydraulic system is provided that is adapted to be installed on a machine that includes an engine and multiple actuators that perform multiple functions of the machine, and the hydraulic system is adapted to control and actuate the multiple actuators of the machine. The hydraulic system includes a plurality of first variable displacement pump/motors adapted to be powered in parallel by the engine and a second variable displacement pump/motor adapted to be connected to the engine in parallel with the first variable displacement pump/motors. The first variable displacement pump/motors are operable to control flow of a first fluid to control first actuators of the multiple actuators and the corresponding functions performed thereby. The second variable displacement pump/motor is adapted to draw power from and deliver power to the engine, draw power from and deliver power to the first actuators through the first variable displacement pump/motors, and control flow of a second fluid to control at least a second actuator of the multiple actuators and the corresponding function performed thereby. The hydraulic system further includes an energy storage device connected in series with the second variable displacement pump/motor and the second actuator. The energy storage device is adapted to accumulate the second fluid pumped thereto by the second variable displacement pump/motor when the second variable displacement pump/motor draws power from the engine or from the first actuators through the first variable displacement pump/motors, and is adapted to deliver the second fluid to the second variable displacement pump/motor when the second variable displacement pump/motor delivers power to the engine or to the first actuators through the first variable displacement pump/motors.

According to a second aspect of the invention, a machine is provided that includes an engine, multiple linear actuators and at least a first rotary actuator that perform functions of the machine, and a hydraulic system that controls and actuates the linear actuators and the first rotary actuator. The hydraulic system includes a plurality of first variable displacement pump/motors powered in parallel by the engine, and a second variable displacement pump/motor connected to the engine in parallel with the first variable displacement pump/motors. The first variable displacement pump/motors are operable to control flow of a first fluid to control at least some of the linear actuators and the corresponding functions performed thereby. The second variable displacement pump/motor is capable of drawing power from and delivering power to the engine, drawing power from and delivering power to at least some of the linear actuators through the first variable displacement pump/motors, and controlling flow of a second fluid to control the first rotary actuator and the corresponding function performed thereby. The hydraulic system further includes an energy storage device connected in series with the second variable displacement pump/motor and the first rotary actuator. The energy storage device is adapted to accumulate the second fluid pumped thereto by the second variable displacement pump/motor when the second variable displacement pump/motor draws power from the engine or from at least some of the linear actuators through the first variable displacement pump/motors, and is adapted to deliver the second fluid to the second variable displacement pump/motor when the second variable displacement pump/motor delivers power to the engine or to at least some of the linear actuators through the first variable displacement pump/motors.

Another aspect of the invention is an excavator machine that includes an engine, multiple linear actuators that control a first set of multiple implements of the machine, at least a first rotary actuator that controls at least a second implement of the machine, and a hydraulic system that controls and actuates the linear actuators and the first rotary actuator. The hydraulic system includes a plurality of first variable displacement pump/motors powered in parallel by the engine, and a second variable displacement pump/motor connected to the engine in parallel with the first variable displacement pump/motors. Each of the first variable displacement pump/motors controls flow of a first fluid to control a corresponding one of the linear actuators and a corresponding one of the first set of multiple implements. The second variable displacement pump/motor is capable of drawing power from and delivering power to the engine, drawing power from and delivering power to the linear actuators through the first variable displacement pump/motors, and controlling flow of a second fluid to control the first rotary actuator and the second implement. The hydraulic system further includes a hydraulic accumulator connected in series with the second variable displacement pump/motor and the first rotary actuator. The hydraulic accumulator is adapted to accumulate the second fluid pumped thereto by the second variable displacement pump/motor when the second variable displacement pump/motor draws power from the engine or from the linear actuators through the first variable displacement pump/motors, and is adapted to deliver the second fluid to the second variable displacement pump/motor when the second variable displacement pump/motor delivers power to the engine or to the linear actuators through first variable displacement pump/motors.

Other aspects of the invention include methods of operating hydraulic systems and machines of the types described above. A particular method includes powering a plurality of first variable displacement pump/motors and a second variable displacement pump/motor that are connected in parallel to an engine of a machine. The first variable displacement pump/motors control flow of a first fluid to control the linear actuators and the corresponding functions performed thereby, and the second variable displacement pump/motor is operated to draw power from or deliver power to the engine, and/or draw power from or deliver power to the linear actuators through the first variable displacement pump/motors, and/or control flow of a second fluid to control the first rotary actuator and the corresponding function performed thereby. The second fluid is accumulated in an energy storage device connected in series with the second variable displacement pump/motor and the first rotary actuator. The energy storage device accumulates the second fluid pumped thereto by the second variable displacement pump/motor when the second variable displacement pump/motor draws power from the engine or from the linear actuators through the first variable displacement pump/motors. Furthermore, the energy storage device delivers the second fluid to the second variable displacement pump/motor when the second variable displacement pump/motor delivers power to the engine or to the linear actuators through the first variable displacement pump/motors.

A technical effect of the invention is the ability of a hydraulic system to capture energy from actuators or an engine of a machine, store the captured energy in an energy storage device, and then deliver the captured energy to the engine/actuators in a controlled manner and time frame. The invention is particularly adapted for use with architectural arrangements of both rotary and linear actuators that are used to control implements of a machine, and offers the possibility of significantly reducing the engine power, energy, and fuel consumption requirements of such machines.

Other aspects and advantages of this invention will be better appreciated from the following detailed description.

### BRIEF DESCRIPTION OF THE DRAWINGS

FIG. 1 schematically represents a compact excavator of a type known in the prior art.

FIG. 2 schematically represents a hybrid (series-parallel) displacement-controlled hydraulic system in accordance with an embodiment of the invention and suitable for controlling linear and rotary actuators of a machine, such as the excavator of FIG. 1.

FIGS. 3 and 4 schematically represent alternative embodiments of hydraulic systems of the invention.

FIG. 5 schematically represents a hydraulic control suitable for use in the hydraulic system of FIG. 4.

FIGS. 6 through 10 schematically represent additional embodiments of hydraulic systems of the invention.

### DETAILED DESCRIPTION OF THE INVENTION

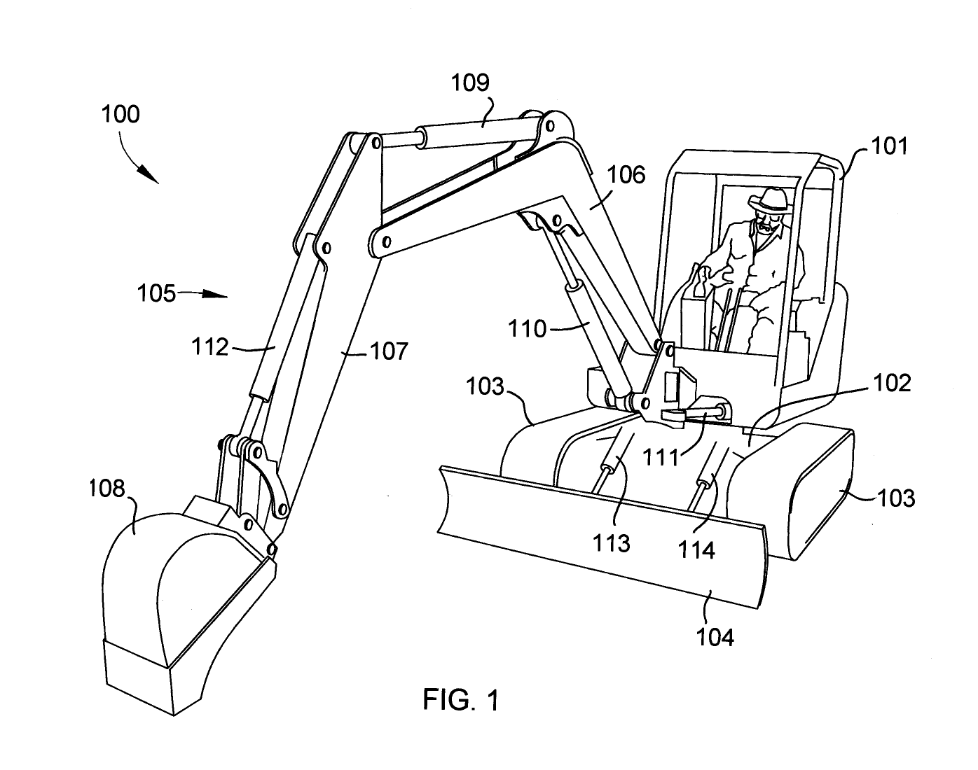

As noted above, the present invention relates to architectural arrangements of hydraulic actuators for machine systems having both rotary and linear actuators, a nonlimiting example of which is the excavator 100 represented in FIG. 1. The invention is a hybrid system adapted to capture energy from the actuators or an engine of the machine, store the captured energy in an energy storage device, and then deliver the stored energy back to the engine and/or actuators in a controlled manner and time frame. According to a particular aspect of the invention, the hybrid system is a purely hydraulic hybrid system in which one or more hydraulic accumulators serve as the energy storage device. As will be appreciated from the following discussion, the linear actuators may be single rod cylinders each controlled by a variable displacement pump using a method referred to as displacement control. The hybrid system is capable of recovering power from the linear actuators, for example, energy from negative loads such as gravity-assisted lowering or actuator braking, and is also capable of transferring the recovered energy back to a variable displacement pump for actuating the linear actuators. According to a preferred aspect of the invention, at least some of the rotary actuators of the system are controlled by a method referred to herein as secondary control, in which a hydraulic pump is connected in series to the accumulator and supplies power to one or more rotary actuators using one or more variable displacement hydraulic motors. Because the excavator 100 of FIG. 1 is a useful example of a machine that utilizes both rotary and linear actuators, the following discussion will make reference to the excavator 100 of FIG. 1, though it should be understood that the invention is not so limited.

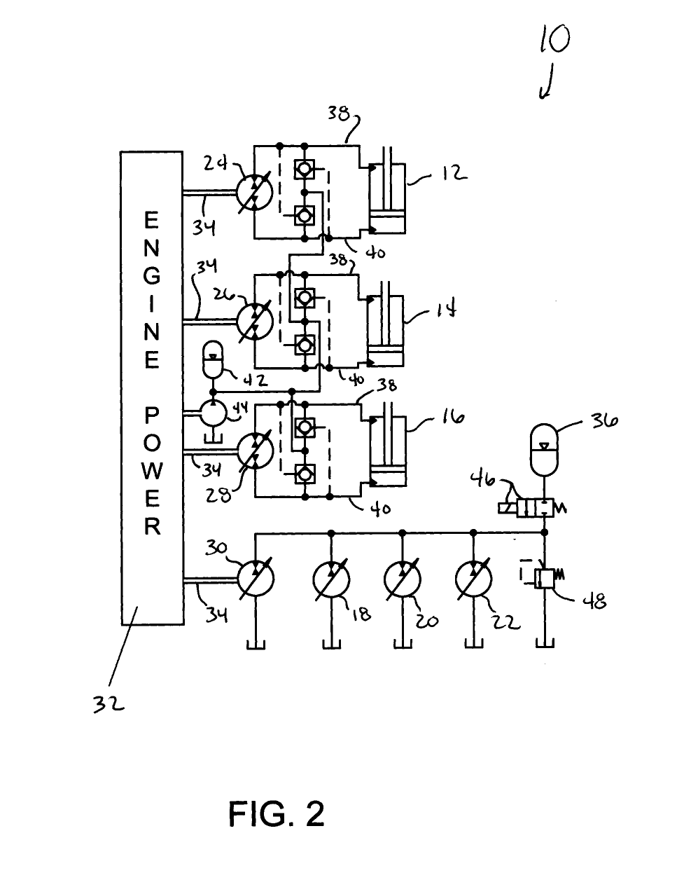

FIG. 2 represents an embodiment of the invention as a system 10 that includes three displacement-controlled linear actuators (hydraulic cylinders) 12, 14 and 16 and three secondary-controlled rotary actuators (motors) 18, 20 and 22, though it should be understood that the invention pertains to any number of linear and rotary actuators as long as there is at least one of each. As a point of reference, the linear actuators 12, 14 and 16 may correspond to any of the linear actuators 109-114 of the excavator 100 of FIG. 1, and the rotary actuators 18, 20 and 22 may correspond to any of the rotary actuators (not shown) of the excavator 100 of FIG. 1. As such, it should be appreciated that the system 10 and its actuators 12 through 22 are suitable for installation on a machine to operate various implements of the machine. Again referring to FIG. 1, the linear actuators 12, 14 and 16 can be adapted to power the blade 104, boom 106, stick 107, bucket 108 and offset functions of the excavator 100, and the rotary actuators 18, 20 and 22 can be variable displacement motors adapted to power the travel (tracks 103) and swing functions of the excavator 100. It is not necessary that the linear actuators 12, 14 and 16 be controlled using displacement control, in that they could be controlled using a single pump and control valves, or by any other means. However, the greatest benefits come when they are controlled using a means that allows energy recovery.

FIG. 2 further depicts the system 10 as what may be referred to as a hybrid displacement-controlled hydraulic system or a series-parallel displacement-controlled hydraulic system for controlling the linear and rotary actuators 12 through 22, and represents an embodiment of the system 10 as comprising four variable displacement pump/motors 24, 26, 28 and 30 connected to an engine 32 by any suitable connection 34, for example, shafts, gear boxes, belt drives, etc. Three of the variable displacement pump/motors 24, 26 and 28 are individually fluidically coupled to the linear actuators 12, 14 and 16, such that the system 10 utilizes a single pump/motor 24, 26 and 28 for each linear actuator 12, 14 and 16, respectively. In contrast, the fourth variable displacement pump/motor 30 is fluidically coupled to all of the rotary actuators 18, 20 and 22. Power can be transferred between these pump/motors 24 through 30 through their connections 34 to the engine 32. Flow of any suitable hydraulic fluid from the pump/motors 24, 26 and 28 to their respective actuators 12, 14 and 16 is represented as being through a hydraulic circuit that includes lines 38 and 40 that supply the hydraulic fluid to either of two chambers of the linear actuators 12, 14 and 16. Each pair of lines 38 and 40 for each actuator 12, 14 and 16 is interconnected with check valves, through which the hydraulic circuit for each pump/motor 24, 26 and 28 is fluidically connected to a low pressure accumulator 42. The engine 32 is represented as driving a charge pump 44 that is fluidically connected to the accumulator 42, which serves as a low pressure flow source for the pump/motors 24, 26 and 28, and not as an energy storage device.

The fourth variable displacement pump/motor 30 can be referred to as an energy storage pump 30, in that the pump 30 is adapted to be responsible for storing excess energy recovered from the linear actuators 12, 14 and 16 and/or delivered by the engine 32 into a high pressure accumulator 36, and then distributing that energy back to the engine 32 and/or the linear actuators 12, 14 and 16 at a later time as needed. The energy storage pump 30 is also responsible for providing the necessary flow for the rotary actuators 18, 20 and 22. As such, an energy storage device in the form of the accumulator 36 is directly linked in series to the energy storage pump 30 and to each of the rotary actuators 18, 20 and 22. In the embodiment of FIG. 2, the secondary-controlled rotary actuators 18, 20 and 22 are in an open circuit, and each rotary actuator 18, 20 and 22 is connected to a reservoir to ensure that a continuous supply of hydraulic fluid is available to each rotary actuator 18, 20 and 22. FIG. 2 further shows the optional inclusion of a valve 46 for locking the hydraulic fluid within the high pressure accumulator 36, and a valve 48 for limiting the pressure within the hydraulic circuit containing the rotary actuators 18, 20 and 22.

As should be apparent from FIG. 2, the linear actuators 12, 14 and 16 and the rotary actuators 18, 20 and 22 may be interconnected solely through their mechanical connections 34 to the engine 32, such that the hydraulic circuit containing the linear actuators 12, 14 and 16 and the hydraulic circuit containing the rotary actuators 18, 20 and 22 may be fluidically isolated from each other and contain two separate fluids. However, it should also be apparent that these hydraulic circuits can be fluidically interconnected as a result of sharing a common reservoir.

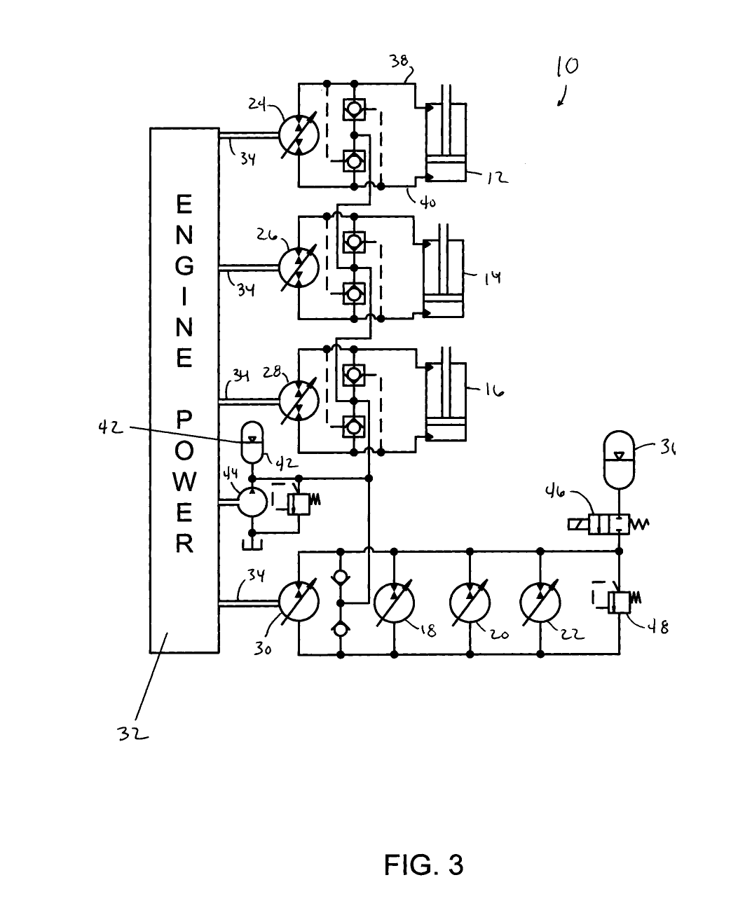

The system 10 represented in FIG. 2 (as well as FIGS. 3-10) can be referred to as a series-parallel hybrid displacement-controlled system in the sense of the following. The circuit containing the rotary actuators 18, 20 and 22 is a series hybrid because power is transferred in series from the engine 32 to the accumulator 36 (operating as a secondary power supply) and the implement(s) controlled by the rotary actuators 18, 20 and 22 (for example, the tracks 103 and/or swing functions of the excavator 100). Furthermore, energy recovered from these same implement(s), for example, energy from negative loads such as actuator braking, can be returned through the same path. This series hybrid circuit operates in parallel with each of the displacement-controlled linear actuators 12, 14 and 16 and the implement(s) controlled by the linear actuators 12, 14 and 16 (for example, the boom 106, stick 107 and bucket 108 of the excavator 100), which can still receive power from the engine 32 and/or the accumulator 36 in parallel. In addition, any power recovered by the linear actuators 12, 14 and 16, for example, energy from negative loads such as gravity-assisted lowering of the implements, can be transferred through their respective connections 34 to the energy storage pump 30, which then stores the recovered energy in the high pressure accumulator 36.

FIG. 3 represents a second embodiment of a hybrid displacement-controlled hydraulic system 10 of the invention that is similar to FIG. 2, but differs from the embodiment of FIG. 2 as a result of the secondary control of the rotary actuators 18, 20 and 22 being within a closed circuit, as opposed to each rotary actuator 18, 20 and 22 being connected to a reservoir as represented in FIG. 2. FIG. 3 shows the closed circuit as also being connected to the low pressure accumulator 42, which ensures that a continuous supply of hydraulic fluid is available to each rotary actuator 18, 20 and 22. As such, the linear actuators 12, 14 and 16 and the rotary actuators 18, 20 and 22 are both mechanically and fluidically interconnected through their mechanical connections 34 to the engine 32 and through the fluid lines to the low pressure accumulator 42, such that the hydraulic circuits containing the linear actuators 12, 14 and 16 and rotary actuators 18, 20 and 22 contain the same hydraulic fluid. However, it should also be apparent that these hydraulic circuits can be fluidically interconnected as a result of sharing a common reservoir.

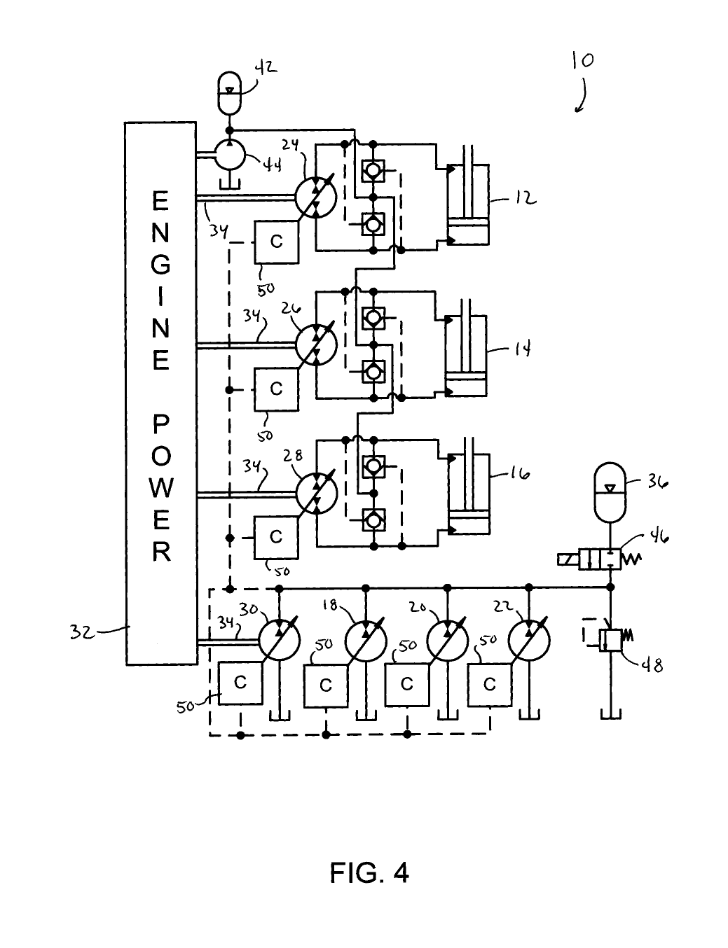

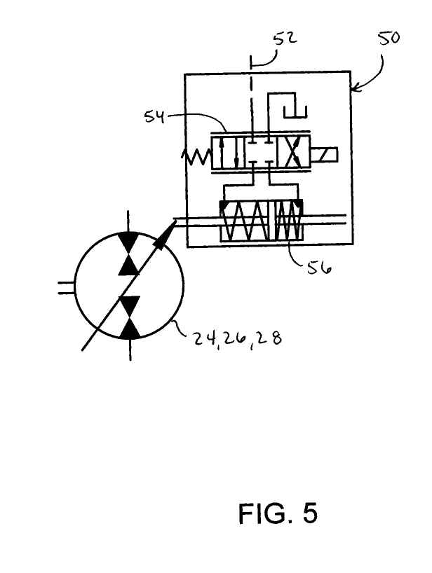

FIGS. 4 and 5 represent a third embodiment of a hybrid displacement-controlled hydraulic system 10 of the invention that is similar to FIG. 2, but differs by showing that the high pressure available from the high pressure accumulator 36 can be used as inputs to controls 50 for each of the variable displacement pump/motors 24, 26 and 28 for the linear actuators 12, 14 and 16 and for the energy storage pump 30 and each rotary actuator 18, 20 and 22. In particular, FIG. 5 represents an example of one of the controls 50 for the pump/motors 24, 26 and 28. The control 50 includes a line-in 52 from the high pressure accumulator 36 and an electronically-controlled hydraulic valve 54 that controls the flow of hydraulic fluid from the line-in 52 to a hydraulic cylinder 56, whose output (position) is used to control the pump/motor 24/26/28 as schematically represented in FIG. 5. This additional capability is beneficial because the high pressure of the accumulator 36 is available within the system 10 at no extra energy cost, and the relative high hydraulic pressure available from the accumulator 36 allows for a reduction in size of the means (valve 54 and cylinder 56) that would typically be used to control the operations of the variable displacement pump/motors 24, 26 and 28. Alternatively, the high pressure available from the accumulator 36 can be employed with valves 54 and cylinders 56 of a more conventional size to more rapidly operate the valves 54 and cylinders 56, resulting in faster control capabilities for the controls 50 and the pump/motors 24, 26 and 28 they control.

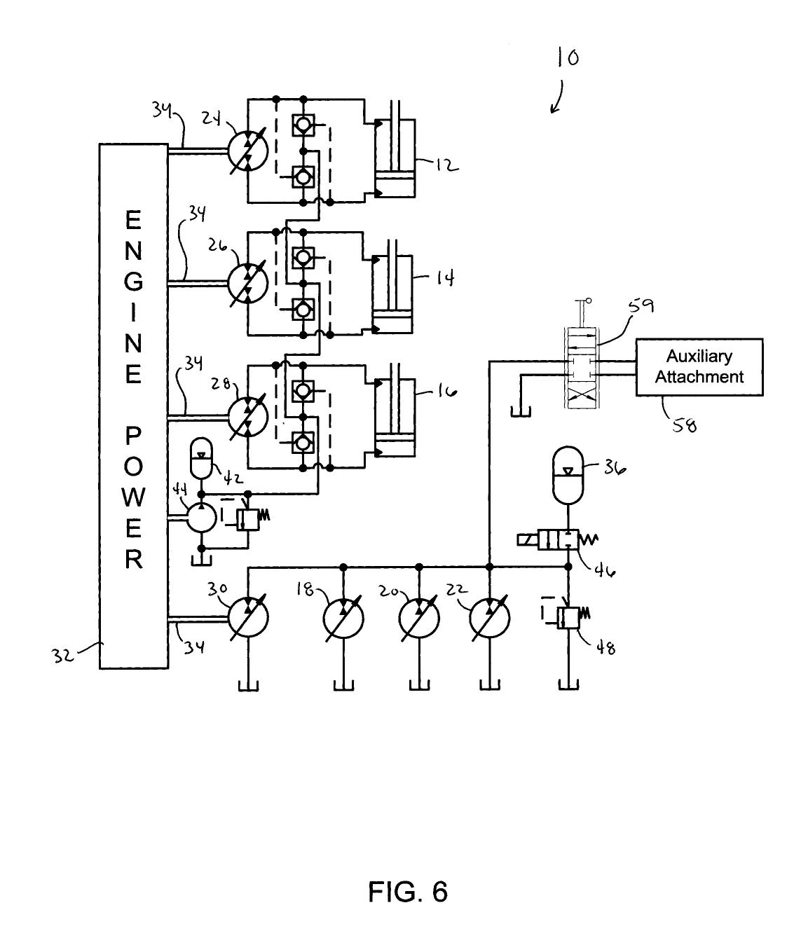

FIG. 6 represents a fourth embodiment of a hybrid displacement-controlled hydraulic system 10 of the invention that is similar to FIG. 2, but differs from the embodiment of FIG. 2 as a result of the inclusion of an auxiliary attachment 58 that is fluidically connected to the energy storage pump 30, rotary actuators 18, 20 and 22, and high pressure accumulator 36 through an electronically-controlled hydraulic valve 59. FIG. 6 is notable for illustrating an additional benefit of the system 10, particularly in relation to conventional displacement control systems, for example, of the type conventional used to control the rotary functions (rotary hydraulic drive motors for the tracks and rotary hydraulic swing motor for the cabin) of excavators of the type represented in FIG. 1. Perhaps the largest disadvantage of conventional displacement control systems is their requirement for one pump for each actuator. For an excavator of the type shown in FIG. 1, such a requirement conventionally necessitates the use of six pump/motors for the six primary functions of the excavator 100 (swing, boom, stick, bucket, left travel track, and right travel track). These machines often have options for high flow auxiliary attachments in addition to the primary working functions of the machine. For excavators utilizing a conventional displacement control system, this would require an additional high flow pump or would require disablement of one of the standard functions to allow one of the pumps to power the auxiliary attachment. In contrast, the system 10 in FIG. 6 is represented as incorporating the auxiliary attachment 58 without the further addition of another pump and without the need to disable a standard function of the machine. It should be appreciated that FIG. 6 represents only one of a variety of possible approaches for powering one or more auxiliary attachments (functions) 58 of the excavator (or other machine) using the energy storage pump 30 in the system 10, evidencing the ability of the system 10 to be more versatile by allowing miscellaneous additional functions to easily be integrated into the system 10 without requiring additional pumps.

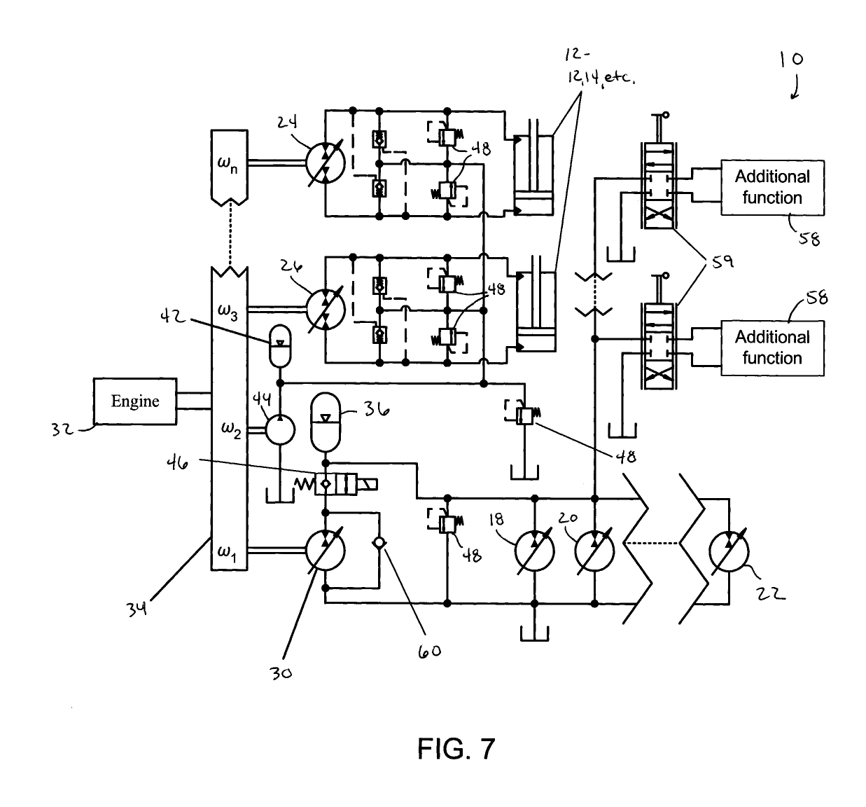

FIGS. 7 through 10 represent further embodiments of hybrid displacement-controlled hydraulic systems 10 of the invention that incorporate various aspects of the embodiments of FIGS. 2 through 6, as well as additional features within the scope of the invention.

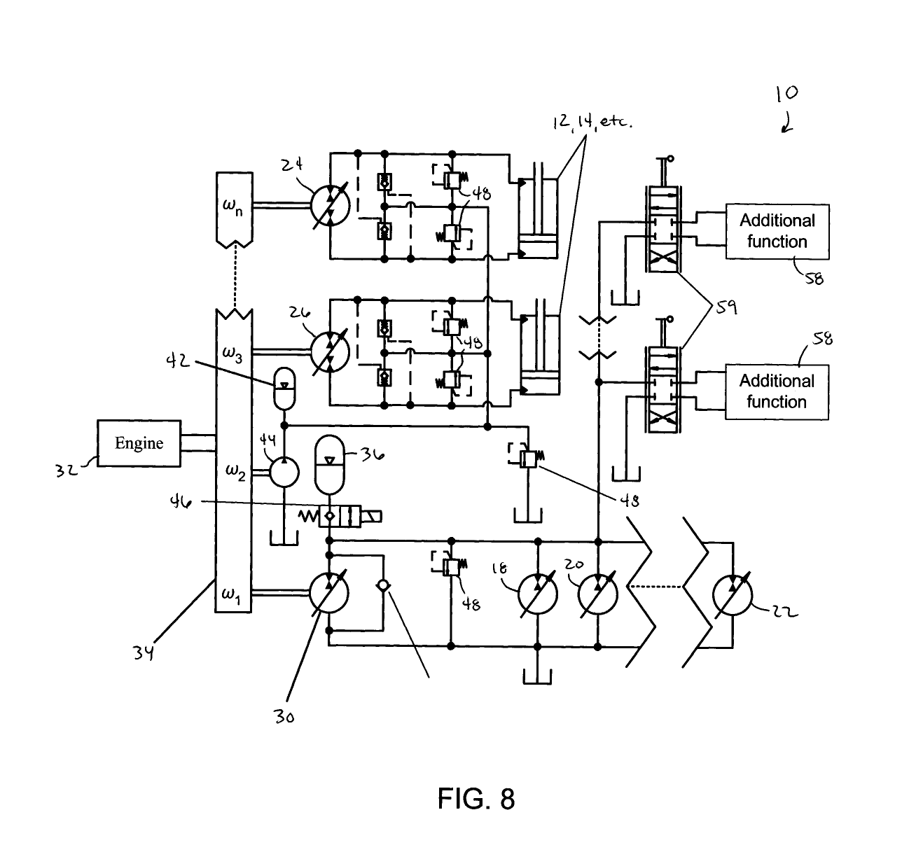

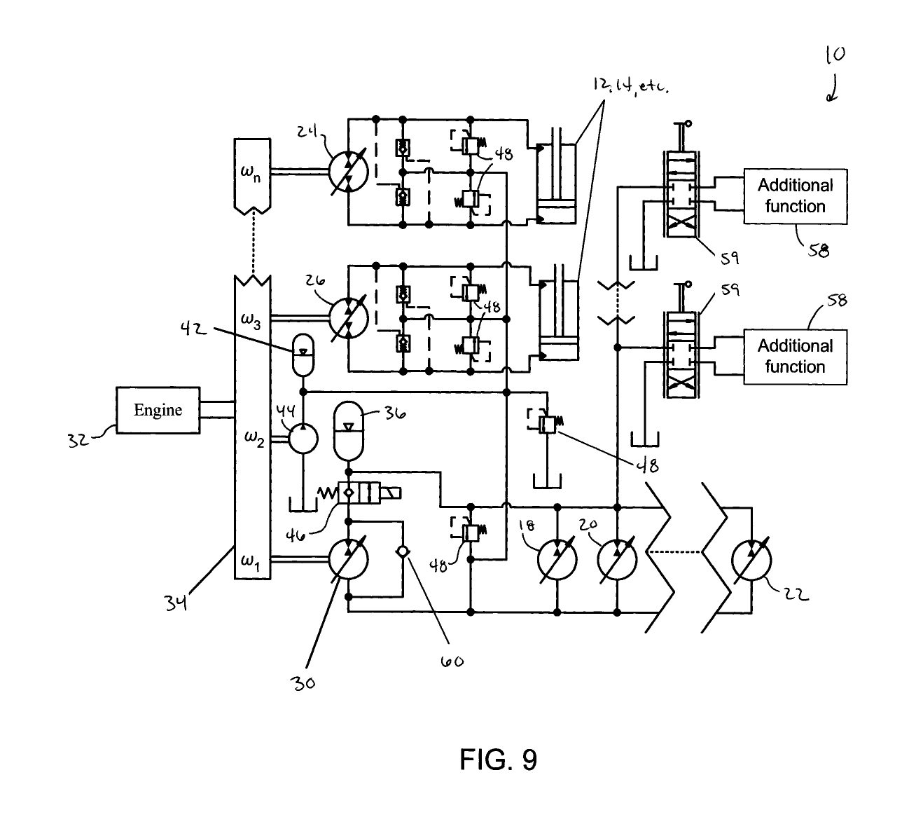

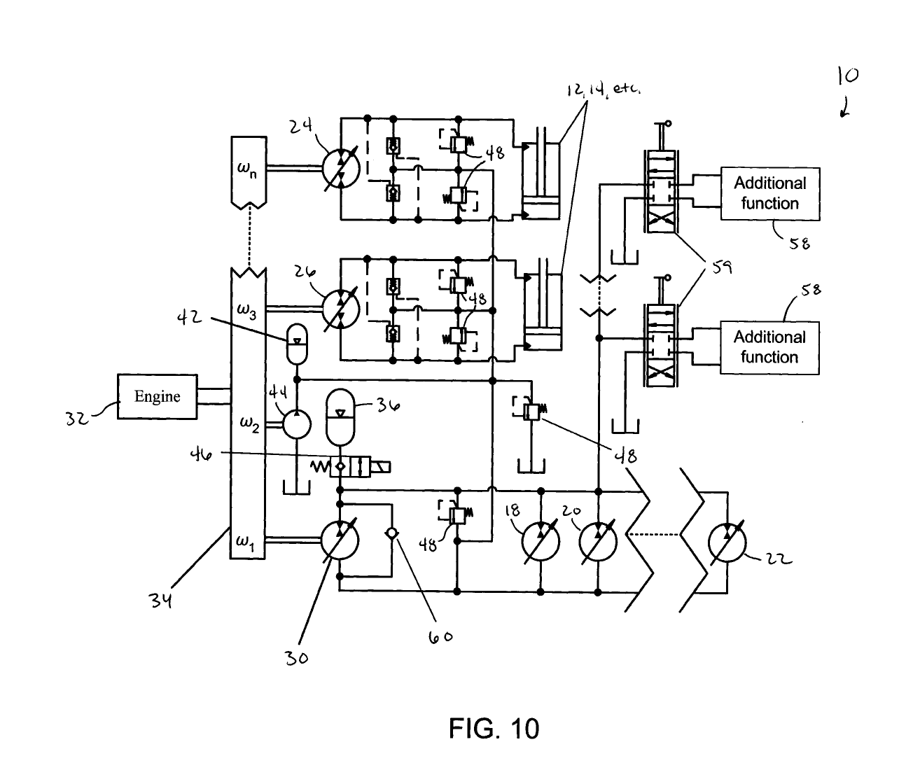

FIGS. 7 and 8 represent open circuit hydraulic systems 10 similar to the open circuit hydraulic systems of FIGS. 2, 4 and 6, and FIGS. 9 and 10 represent closed circuit hydraulic systems 10 similar to the closed circuit hydraulic system of FIG. 3. Each of FIGS. 7 through 10 further represents its respective system 10 as including an anti-cavitation valve 60, which can be of a type known used in conventional hydraulic systems. In addition, the systems 10 of FIGS. 7 through 10 are further represented as including additional valves 48 for limiting pressures within the individual hydraulic circuits associated with the variable displacement pump/motors 24, 26 and 28 that control the linear actuators 12, 14 and 16. The open circuit systems 10 of FIGS. 7 and 8 differ from each other and the closed circuit systems 10 of FIGS. 9 and 10 differ from each other by the manner in which their respective locking valves 46 are positioned. Finally, each of FIGS. 7 through 10 represents the inclusion of multiple auxiliary attachments (functions) 58, similar to FIG. 6, and each represents line breaks that represent that any number of linear actuators 12, 14 and 16 and rotary actuators 18, 20 and 22 can be incorporated in the systems 10.

From the above, it can be seen that the present invention and hybrid displacement-controlled systems 10 thereof can achieve significant energy savings as compared to conventional control systems in which control of the functions of a multi-function machine is accomplished by means of directional control valves, and in which throttling flow through the control valves results in wasted energy. In addition, the invention offers further energy savings by providing a means to recover and store energy from the machine actuators. Because energy can be stored and power can be transferred between the linear actuators 12, 14 and 16 and the rotary actuators 18, 20 and 22, the invention also makes it possible to reduce the peak power requirement and improve the operating efficiency of the engine 32 (or other power supply) by controlling the load using the energy stored in the high pressure accumulator 36, while still being capable of providing peak power demands to the actuators 12 through 22. Compared to alternate hybrid system designs, the hybrid systems 10 of this invention are capable of reducing the number of components needed to control the actuators 12 through 22 because a single pump 30 can be used for all rotary actuators 18, 20 and 22 in the system 10. The invention can also be beneficial to systems, equipment and machines that use displacement-controlled linear actuators because the high pressure accumulator 36 is capable of providing a high pressure source that can improve the response of the displacement-controlled actuators and allow the actuators to be more compact.

Results from a simulation study using mathematical models that compared a conventional non-hybrid displacement-controlled hydraulic system with hybrid displacement-controlled systems 10 of this invention demonstrated that the rated engine power of an engine of an excavator (for example, FIG. 1) could be reduced by approximately half with the hybrid systems 10 without losing any performance from the digging functions of the excavator. Furthermore, the simulation predicted that excavators equipped with the hybrid systems 10 may consume about 20% less fuel than the simulated non-hybrid displacement-controlled systems based on a high power cycle when the excavator was operated by an expert operator, and even greater fuel savings were predicted if the excavator were operated by a novice operator on a low power cycle. Simulations also quantified benefits of hybrid hydraulic systems 10 of the invention, particularly in terms of engine power, energy, and fuel consumption.

In addition to excavators, the invention can be implemented on a variety of heavy mobile hydraulic machines, such as wheel loaders and other similar material-handling machines having both linear and rotary actuators. Suitable pumping capacities of the pump/motors 24, 26 and 28 and the energy storage pump 30 and suitable operating pressures and capacities for the high pressure accumulator 36 and low pressure accumulator 42 will depend on the particular application.

While the invention has been described in terms of specific embodiments, it is apparent that other forms could be adopted by one skilled in the art. For example, the functions of certain components of the systems could be performed by components of different construction but capable of a similar (though not necessarily equivalent) function. Furthermore, other methods of control could be used for control of the linear actuators 12, 14 and 16 than described. For example a single pump could be used to provide flow and pressure and control valves could be used to control the motion of the linear actuators 12, 14 and 16. Though power could still be transferred from the accumulator 36 to the linear actuators 12, 14 and 16, using such a method would reduce the efficiency of the invention as a result of preventing power from being recovered from the linear actuators 12, 14 and 16 to be stored in the accumulator 36. Accordingly, it should be understood that the invention is not limited to the specific embodiment illustrated in the drawings, and the scope of the invention is to be limited only by the following claims.

1. A hydraulic system adapted to be installed on a machine comprising an engine and multiple actuators that perform multiple functions of the machine, the hydraulic system being adapted to control and actuate the multiple actuators of the machine, the hydraulic system comprising:
a plurality of first variable displacement pump/motors adapted to be powered in parallel by the engine, the first variable displacement pump/motors being operable to control flow of a first fluid to control first actuators of the multiple actuators and the corresponding functions performed thereby;
a second variable displacement pump/motor adapted to be connected to the engine in parallel with the first variable displacement pump/motors, draw power from and deliver power to the engine, draw power from and deliver power to the first actuators through the first variable displacement pump/motors, and control flow of a second fluid to control at least a second actuator of the multiple actuators and the corresponding function performed thereby; and
an energy storage device connected in series with the second variable displacement pump/motor and the second actuator, the energy storage device being adapted to accumulate the second fluid pumped thereto by the second variable displacement pump/motor when the second variable displacement pump/motor draws power from the engine or from the first actuators through the first variable displacement pump/motors and being adapted to deliver the second fluid to the second variable displacement pump/motor when the second variable displacement pump/motor delivers power to the engine or to the first actuators through the first variable displacement pump/motors.

2. The hydraulic system according to claim 1, wherein the first actuators of the multiple actuators are linear actuators.

3. The hydraulic system according to claim 2, wherein the linear actuators control implements of the machine.

4. The hydraulic system according to claim 1, wherein the machine is an excavator and the implements include at least one implement chosen from the group consisting of blades and articulating mechanical arms.

5. The hydraulic system according to claim 1, wherein the second actuator of the multiple actuators is a rotary actuator.

6. The hydraulic system according to claim 1, wherein the machine is an excavator and the rotary actuator controls an implement of the machine chosen from the group consisting of tracks and a swing for rotating a cab of the machine.

7. The hydraulic system according to claim 1, wherein the energy storage device comprises a hydraulic accumulator.

8. The hydraulic system according to claim 1, wherein hydraulic system is installed on the machine.

9. A machine comprising an engine, multiple linear actuators and at least a first rotary actuator that perform functions of the machine, and a hydraulic system for controlling and actuating the linear actuators and the first rotary actuator, the hydraulic system comprising:
a plurality of first variable displacement pump/motors powered in parallel by the engine, the first variable displacement pump/motors being operable to control flow of a first fluid to control at least some of the linear actuators and the corresponding functions performed thereby;
a second variable displacement pump/motor connected to the engine in parallel with the first variable displacement pump/motors, the second variable displacement pump/motor drawing power from and delivering power to the engine, drawing power from and delivering power to the at least some of the linear actuators through the first variable displacement pump/motors, and controlling flow of a second fluid to control the first rotary actuator and the corresponding function performed thereby; and
an energy storage device connected in series with the second variable displacement pump/motor and the first rotary actuator, the energy storage device being adapted to accumulate the second fluid pumped thereto by the second variable displacement pump/motor when the second variable displacement pump/motor draws power from the engine or from the at least some of the linear actuators through the first variable displacement pump/motors and being adapted to deliver the second fluid to the second variable displacement pump/motor when the second variable displacement pump/motor delivers power to the engine or to the at least some of the linear actuators through the first variable displacement pump/motors.

10. The machine according to claim 9, wherein the linear actuators control implements of the machine.

11. The machine according to claim 10, wherein the machine is an excavator and the implements include at least one implement chosen from the group consisting of blades and articulating mechanical arms.

12. The machine according to claim 9, wherein the first rotary actuator is a variable displacement motor.

13. The machine according to claim 9, further comprising at least a second rotary actuator that is connected in series with the first rotary actuator, the energy storage device, and the second variable displacement pump/motor and performs one of the functions of the machine.

14. The machine according to claim 9, wherein the machine is an excavator and the first rotary actuator controls an implement of the machine chosen from the group consisting of tracks and a swing for rotating a cab of the machine.

15. The machine according to claim 9, wherein the energy storage device comprises a hydraulic accumulator.

16. An excavator machine comprising an engine, multiple linear actuators that control a first set of multiple implements of the machine, at least a first rotary actuator that controls at least a second implement of the machine, and a hydraulic system for controlling and actuating the linear actuators and the first rotary actuator, the hydraulic system comprising:
a plurality of first variable displacement pump/motors powered in parallel by the engine, each of the first variable displacement pump/motors controlling flow of a first fluid to control a corresponding one of the linear actuators and a corresponding one of the first set of multiple implements;
a second variable displacement pump/motor connected to the engine in parallel with the first variable displacement pump/motors, the second variable displacement pump/motor drawing power from and delivering power to the engine, drawing power from and delivering power to the linear actuators through the first variable displacement pump/motors, and controlling flow of a second fluid to control the first rotary actuator and the second implement; and
a hydraulic accumulator connected in series with the second variable displacement pump/motor and the first rotary actuator, the hydraulic accumulator being adapted to accumulate the second fluid pumped thereto by the second variable displacement pump/motor when the second variable displacement pump/motor draws power from the engine or from the linear actuators through the first variable displacement pump/motors, and being adapted to deliver the second fluid to the second variable displacement pump/motor when the second variable displacement pump/motor delivers power to the engine or to the linear actuators through first variable displacement pump/motors.

17. The excavator machine according to claim 16, wherein the first set of multiple implements includes at least one implement chosen from the group consisting of blades and articulating mechanical arms.

18. The excavator machine according to claim 16, wherein the second implement is chosen from the group consisting of tracks and a swing for rotating a cab of the excavator machine.

19. A method of operating a machine comprising an engine, multiple linear actuators and at least a first rotary actuator that perform functions of the machine, and a hydraulic system for controlling and actuating the linear actuators and the first rotary actuator, the method comprising:
powering a plurality of first variable displacement pump/motors in parallel with the engine, the first variable displacement pump/motors controlling flow of a first fluid to control the linear actuators and the corresponding functions performed thereby;
operating a second variable displacement pump/motor connected to the engine in parallel with the first variable displacement pump/motors to draw power from or deliver power to the engine, draw power from or deliver power to the linear actuators through the first variable displacement pump/motors, and control flow of a second fluid to control the first rotary actuator and the corresponding function performed thereby;
accumulating the second fluid in an energy storage device connected in series with the second variable displacement pump/motor and the first rotary actuator, the energy storage device accumulating the second fluid pumped thereto by the second variable displacement pump/motor when the second variable displacement pump/motor draws power from the engine or from the linear actuators through the first variable displacement pump/motors; and
delivering the second fluid from the energy storage device to the second variable displacement pump/motor when the second variable displacement pump/motor delivers power to the engine or to the linear actuators through the first variable displacement pump/motors.

20. The method according to claim 19, wherein the linear actuators and the first rotary actuator control implements that perform the functions of the machine, and the implements include at least one implement chosen from the group consisting of blades, articulating mechanical arms, tracks, and a swing for rotating a cab of the machine.
